(19) United States
(12) Patent Application Publication
(10) Pub. No.: US 2008/0228964 A1
(43) Pub. Date: Sep. 18, 2008

(54) Hybrid flex-and-board memory interconnect system

(76) Inventor: Henning Braunisch, Chandler, AZ (US)

Correspondence Address: INTEL CORPORATION;c/o INTELLEVATE, LLC, P.O. BOX 52050, MINNEAPOLIS, MN, 55402, US

(21) Appl. No.: 11/717,568

(22) Filed: Mar. 13, 2007

(51) Int. Cl. G06F 3/00

(52) U.S. Cl. 710/38

(57) ABSTRACT

A hybrid memory interconnect system involving flexible cable and board interconnects is provided for improved memory bandwidth and power efficiency performance. To this purpose, signals between a microprocessor chip and one or more memory chips are routed via separate conductive paths, e.g. flexible cable for high-speed signals and conventional board interconnects for low-speed signals. The memory chips may be connected to a flexible cable and a supporting printed circuit board in various ways.

### BACKGROUND

1. Technical Field

Embodiments of the invention relate to a hybrid interconnect system involving flex and board interconnects for board-mounted components.

2. Description of Related Art

Advancements in processor performance have outpaced memory advancements to an extent that memory systems have become a source of bandwidth and latency problems.

In one example of a chipset-based platform, a Memory Controller Hub (MCH) is connected to a Central Processing Unit (CPU) via Front Side Bus (FSB) or Common System Interconnect (CSI). The MCH is also connected to one or more Dynamic Random Access Memory (DRAM) devices via single-ended double data rate (DDR) interconnects. This architecture, however, reduces memory bandwidth performance and increases latency problems, both of which cause bottlenecks in computer system performance.

To improve memory bandwidth while providing a large memory capacity, the Fully Buffered Dual In-line Memory Module (FB-DIMM) technology may be employed. With the FB-DIMM technology, a direct signaling interface, provided between a memory controller and several DRAM chips, is split into two independent signaling interfaces with a buffer therebetween. The buffer, also known as the Advanced Memory Buffer (AMB), has a point-to-point serial interface which is configured to only respond to memory controller commands. While this architecture provides a larger memory bandwidth, there is a trade-off in input/output (I/O) power efficiency.

### BRIEF DESCRIPTION OF THE DRAWINGS

FIG. 1 illustrates one embodiment having a memory chip directly mounted on a printed circuit board.

FIG. 2 illustrates one embodiment having a memory chip mounted on a memory module.

FIG. 3 illustrates one embodiment having a memory chip mounted on a memory card.

FIG. 4 illustrates one embodiment having a memory chip mounted on a flexible cable.

### DETAILED DESCRIPTION OF ILLUSTRATIVE EMBODIMENTS

In the following description, numerous specific details are set forth in order to provide a thorough understanding of various illustrative embodiments of the present invention. It will be understood, however, to one skilled in the art, that embodiments of the present invention may be practiced without some or all of these specific details. In other instances, well known process operations have not been described in detail in order not to unnecessarily obscure pertinent aspects of embodiments being described. In the drawings, like reference numerals refer to same or similar functionalities or features throughout the several views.

Embodiments of the invention relate to a hybrid flex-and-board memory interconnect system in which signals between a microprocessor chip and one or more memory chips are transmitted or routed via separate conductive paths, e.g. high-speed and low-speed channels. Generally, a first conductive path transmitting high-speed signals is separate from a printed circuit board upon which a second conductive path is formed to transmit low-speed signals. More specifically, high-speed signals, e.g. data signals, may be transmitted by serial differential signaling through flexible cables (flex-circuit boards or high-speed ribbon cables), also referred to in short as flex in the following. Low-speed signals, e.g. single-ended address and control signals, may be transmitted through conventional interconnects, e.g. standard socket, pins and/or conductive traces on a printed circuit board, coupling the microprocessor chip and the memory chips. In some embodiments, high-speed signals may refer to electric signals transmitted at a signaling rate of about 5 Gb/s (Gigabits per second) or higher, but are not limited as such. With high-speed signaling on flex and low-speed signaling on standard interconnects, valuable pins on flex are conserved for high-speed signaling which operate at high bandwidths and low power levels, while bandwidth-limited standard pins operating at relatively lower speeds are utilized for the large numbers of single-ended address and control signals. This hybrid flex-and-board interconnect system results in improved system architecture with an overall improved performance in bandwidth, power and cost.

As an illustration, though not limited as such, an embodiment of the invention may be used in memory architectures or systems involving the Rambus® XDR™2 DRAM. The XDR™2 DRAM provides two signaling levels: Differential Rambus Signaling Levels (DRSL) and Rambus Signaling Levels (RSL). The DRSL is used for scalable high-speed point-to-point bi-directional data signals operating at about 3.2 GHz, while RSL is used for source synchronous bussed address and command signals to multiple DRAM devices operating at a lower speed at about 800 MHz. Therefore, in conjunction with embodiments of the invention, the differential portion DRSL may be deployed on flex to transmit high-speed data signals, while the single-ended RSL portion may be routed through the motherboard to transmit low-speed addresses and control signals. However, it should be appreciated that embodiments of the invention are not limited to memory architectures involving Rambus® XDR™2 DRAM.

Embodiments of the invention are also applicable to other memory systems with suitable modifications. Generally, a suitable memory system may be configured to separate a memory bus into a plurality of high-speed signals and a plurality of low-speed signals. At least part of both the high-speed and the low-speed signals are transmitted via their respective high-speed and low-speed channels separately. According to embodiments of the invention, high-speed signals, e.g. data signals, may be transmitted between a memory chip and a microprocessor chip through a flexible cable coupled therebetween, while low-speed signals, e.g. address and control signals, may be transmitted between a memory chip and a microprocessor chip through conductive traces formed on a printed circuit board and coupling the memory and microprocessor chips.

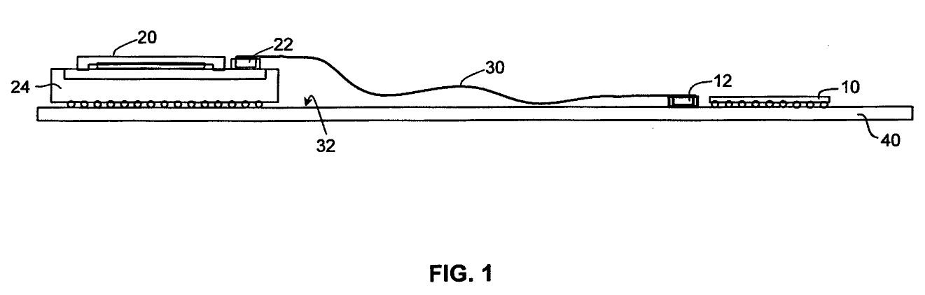

Various connection configurations are available to implement a hybrid flex-and-board memory interconnect system. FIGS. 1 to 4 show four illustrative embodiments, but it should be appreciated that the invention is not limited to the illustrations described herein. In the following paragraphs, it should be understood that the terms “memory chip” and “microprocessor chip” refer to packaged or unpackaged integrated circuits, chips or dies containing circuitry to perform the logic of its intended application.

FIG. 1 illustrates a first embodiment in which a memory module comprises at least a memory chip 10 coupled to a high-speed connector 12 (or high-speed connection), both of which are directly mounted on a printed circuit board 40. The high-speed connector 12 at the memory chip 10 receives in conductive coupling one end of a flex cable 30 which also has a distal end coupled to a high-speed interface 22 at a microprocessor chip 20 for transmission of high-speed signals between the microprocessor chip 20 and the memory chip 10.

In the embodiment of FIG. 1, the memory chip 10 is mounted directly on the printed circuit board 40 via an appropriate low-speed interface and in conductive coupling with conductive traces 32 formed on the printed circuit board 40 to route low-speed signals between the microprocessor chip 20 and the memory chip 10. Examples of an appropriate low-speed connection or connector at the memory chip 10 include, but are not limited to, an array of solder balls, pins or land pads. The memory chip 10 may be coupled to the printed circuit board 40 using methods such as controlled-collapse chip connection (C4) or ball grid array (BGA) technology.

In this and other embodiments of FIGS. 1 to 4, the microprocessor chip 20 is coupled to a high-speed connector 22 which receives one end of the flex cable 30 distal from the memory chip 10. Both the microprocessor chip 20 and its high-speed connector 22 may be mounted on a socket 24. The high-speed connector 22 may be integrated into socket 24 to form a split-socket, a split-connector or a two-part connector. The pin field in the split-socket may be divided into two separate segments: the first segment to connect the microprocessor chip 20 to conductive traces 32 formed on the printed circuit board 40 via standard socket technology for low-speed signal routing, and the second separate segment to connect the microprocessor chip 20 to the flex cable 30 for high-speed signal routing. An appropriate interface between the socket 24 and the printed circuit board 40 includes, but is not limited to, an array of solder balls, pins or land pads (lands).

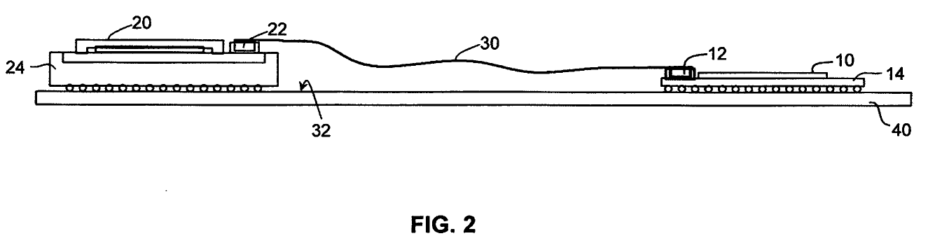

FIG. 2 illustrates a second embodiment in which a memory module comprises at least one memory chip 10 coupled to a high-speed connector 12 (or high-speed connection), both of which are mounted on a substrate 14 which is coupled to conductive traces 32 on a printed circuit board 40. The high-speed connector 12 at the memory chip 10 receives in conductive coupling one end of a flex cable 30 which has a distal end coupled to a high-speed connector 22 at the microprocessor chip 20 for transmission of high-speed signals between the microprocessor chip 20 and the memory chip 10. The substrate 14 may be a layered structure comprising metallic or conductive materials clad with insulation materials. Examples of a conductive material include, but are not limited to, copper, tungsten, silver, gold, platinum and any alloy thereof. Examples of an insulation material include, but are not limited to, epoxy resin, polyimide, cyanate ester, glass fibers, Ajinomoto Buildup Film (ABF), Bismaleimide Triazine (BT), a mixture of epoxy resin and glass fibers (FR5) and ceramics, e.g. high-temperature co-fired ceramics (HTCC) or low-temperature co-fired ceramics (LTCC).

In the embodiment of FIG. 2, the memory chip 10 is mounted on substrate 14 which is mounted on a printed circuit board 40 via an appropriate low-speed interface. Examples of an appropriate low-speed connection or connector at the memory chip 10 include, but are not limited to, an array of balls, pins or land pads. The substrate 14 at the memory chip 10 couples the memory chip 10 to conductive traces 32 formed on the printed circuit board 40. The conductive traces are routed to transmit low-speed signals between the microprocessor chip 20 and the memory chip 10.

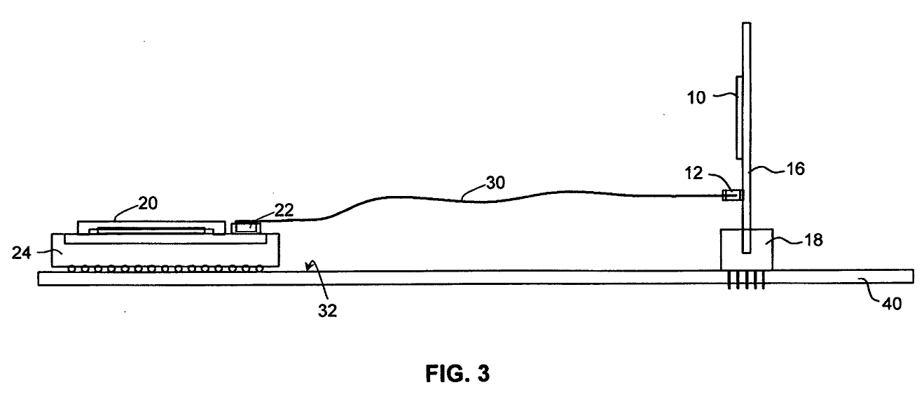

FIG. 3 illustrates a third embodiment in which a memory module comprises at least one memory chip 10 coupled to a high-speed connector 12 (or high-speed connection), both of which are mounted on a memory card 16. The high-speed connector 12 receives in conductive coupling one end of a flex cable 30 which has a distal end coupled to a high-speed connector 22 of a microprocessor chip 20 for transmission of high-speed signals between the microprocessor chip 20 and the memory chip 10.

In the embodiment of FIG. 3, the memory chip 10 is mounted on a memory card 16 which is conductively coupled to a printed circuit board 40 via a memory card connector 18. The memory card 16 may include conductive traces formed thereon which are conductively coupled, via an appropriate low-speed interface, to conductive traces 32 on the printed circuit board 40 to route low-speed signals between the memory chip 10 and the microprocessor chip 20. Examples of an appropriate low-speed connection or connector for coupling a memory card 16 to a printed circuit board 40 include, but are not limited to, a through-hole mount pin interface.

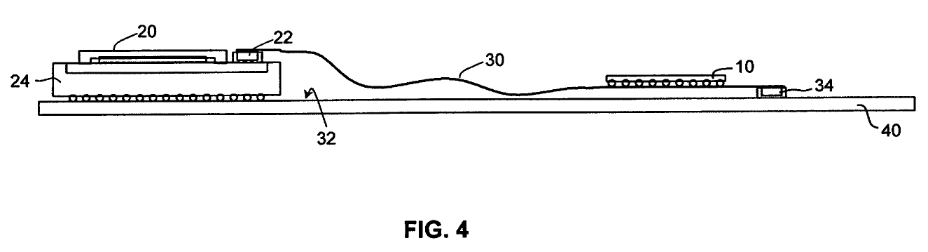

FIG. 4 illustrates a fourth embodiment in which a memory module comprises at least one memory chip 10 which is directly affixed or coupled to a flex cable 30, such as by soldering, to provide a high-speed connection. The flex cable 30 has one end in conductive coupling with a high-speed connector 22 of a microprocessor chip 20. The flex cable 30 also has a distal end conductively coupled to a low-speed connector 34 (or low-speed connection) mounted on a printed circuit board 40. The flex memory chip 10 may be affixed to the flex cable 30 between its two ends and accordingly, high-speed signals are transmitted between the microprocessor chip 20 and the memory chip 10 through a first portion of the flex cable 30. Low speed signals may be transmitted between the memory chip 10 and the microprocessor chip 20 via a second portion of the flex cable 30, the low-speed connector 34 and conductive traces 32 routed on the printed circuit board 40 to the microprocessor chip 20. The low-speed connector 34 mounted on the printed circuit board 40 may also deliver electrical power to the memory chip 10.

In these and other embodiments, the flex cable 30 may comprise an insulation material and a conductive material. Examples of the conductive material include, but are not limited to, copper, tungsten, silver, gold, platinum and any alloy or layered composition thereof. Examples of the insulation material include, but are not limited to, polyvinyl chloride (PVC), polyethylene, polyimide, liquid crystal polymers (LCPs), and benzocyclobutene (BCB), and combinations thereof.

Other embodiments will be apparent to those skilled in the art from consideration of the specification and practice of the present invention. Furthermore, certain terminology has been used for the purposes of descriptive clarity, and not to limit the invention. The embodiments and features described above should be considered exemplary, with the invention being defined by the appended claims.

What is claimed is:

1. A system comprising:
a printed circuit board;
a microprocessor chip coupled to the printed circuit board;
a memory chip;
a first conductive path, separate from the printed circuit, coupling the microprocessor chip with the memory chip to transmit a high-speed signal therebetween; and
a second conductive path, formed on the printed circuit board, coupling the microprocessor chip with the memory chip to transmit a low-speed signal therebetween.

2. The system of claim 1, wherein the first conductive path is a flexible cable and the second conductive path is a conductive trace separate from the flexible cable.

3. The system of claim 1, wherein the high-speed signal comprises a data signal, and the low-speed signal comprises an address signal or a control signal.

4. The system of claim 2, wherein the microprocessor chip is mounted on a split socket having a first interface connecting to the flexible cable to transmit the high-speed signal, and a second interface connecting to the printed circuit board to transmit the low-speed signal.

5. The system of claim 2, further comprising a high-speed connector coupling the memory chip to an end of the flexible cable and directly mounted on the printed circuit board, wherein the memory chip is directly mounted on the printed circuit board in conductive coupling with the conductive trace.

6. The system of claim 2, further comprising a high-speed connector coupling the memory chip to an end of the flexible cable, wherein the high-speed connector and the memory chip are mounted on a substrate which conductively couples the memory chip to the conductive trace on the printed circuit board.

7. The system of claim 2, further comprising a high-speed connector coupling the memory chip to an end of the flexible cable, wherein the high-speed connector and the memory chip are mounted on a card which conductively couples the memory chip to the conductive trace on the printed circuit board.

8. The system of claim 2, wherein the memory chip is coupled directly to the flexible cable which includes an end coupled to a high-speed connector of the microprocessor chip and a distal end coupled to a low-speed connector mounted on the printed circuit board, wherein the low-speed connector conductively couples the memory chip to the conductive trace on the printed circuit board.

9. The system of claim 2, wherein the high-speed signal has a signaling rate of at least about 5 Gb/s.

10. A memory system comprising:
a memory chip configured to separately transmit a high-speed signal and a low-speed signal;
a high-speed connection conductively coupling the memory chip with a flexible conductor to transmit the high-speed signal; and
a low-speed connection, separate from the high-speed connection, conductively coupling the memory chip with a conductive trace formed on a printed circuit board to transmit the low-speed signal.

11. The memory system of claim 10, wherein the high-speed and the low-speed signals are to be transmitted between the memory chip and a microprocessor chip.

12. The memory system of claim 11, wherein the low-speed connection comprises an array of solder balls, solder pins or land pads.

13. The memory system of claim 10, wherein the memory chip is directly mounted on the printed circuit board to provide the low-speed connection.

14. The memory system of claim 10, wherein the memory chip and the high-speed connector are mounted on a substrate which is mounted on the printed circuit board to provide the low-speed connection.

15. The memory system of claim 10, wherein the memory chip and the high-speed connector are mounted on a card which is mounted on the printed circuit board to provide the low-speed connection.

16. The memory system of claim 10, wherein the memory chip is directly coupled to the flexible cable which includes an end coupled to the microprocessor chip and a distal end coupled to the low-speed connection which is mounted on the printed circuit board.

17. The memory system of claim 10, wherein the low-speed interface comprises an array of solder balls, solder pins and land pads.

18. A signal routing method in a memory system, comprising:
separating a memory bus into a plurality of high-speed signals and a plurality of low-speed signals;
transmitting at least partially the plurality of high-speed signals between a memory chip and a microprocessor chip through a flexible cable coupled therebetween; and
transmitting at least partially the plurality of low-speed signals between the memory chip and the microprocessor chip through a conductive trace formed on a printed circuit board.

19. The method of claim 18, wherein the plurality of high-speed signals comprise a data signal, and the plurality of low-speed signals comprise an address signal or a control signal.
